(19) United States
(12) Patent Application Publication
(10) Pub. No.: US 2013/0138519 A1
(43) Pub. Date: May 30, 2013

(54) Point of Sale Activation and Reload System

(71) Applicant: Keith McKenzie, Toronto (CA)

(72) Inventor: Keith McKenzie, Toronto (CA)

(21) Appl. No.: 13/481,513

(22) Filed: May 25, 2012

Related U.S. Application Data
(60) Provisional application No. 61/490,570, filed on May 26, 2011.

(51) Int. Cl. G06Q 20/20

(52) U.S. Cl. CPC G06Q 20/204
USPC 705/17

(57) ABSTRACT

The present invention relates generally to the use of point of sale transactions at point-of-sale terminals (POST) enabling users to simultaneously activate and assign a monetary value to a voucher card system using standard debit card transaction networks.

### FIELD OF THE INVENTION

The present invention relates generally to methods of conducting point of sale transactions at point-of-sale terminals (POST) that enable users to simultaneously activate and assign a monetary value to a voucher card system using standard debit card transaction networks.

### BACKGROUND OF THE INVENTION

Point-of-sale transaction systems enable consumers to use a debit card to initiate and complete financial transactions through banking networks. As is known, a consumer who has been issued a banking card may use that card with a merchant having a point-of-sale terminal to electronically access the consumer's bank account to transfer the transaction funds from the consumer's bank account to the merchant's bank account.

The debit card system has been effectively operating for the past 15-20 years and provides a robust and effective system for electronic transactions involving the straightforward exchange of money for goods or services.

With certain consumer products or services, it is necessary to activate the product prior to the consumer being able to use the product. For example, phone cards and reward cards (as a specific form of a consumer product) often require activation before enabling the consumer to use them. Activation is generally required to discourage theft of the cards as cards that have not been activated cannot be used. In the past, as the activation process must be completed using specialized merchant equipment, activation of stolen cards is difficult as the thief would have to use this equipment to activate any stolen cards.

During the activation process, coded data on the product (eg. a gift card) is sent to a specific database that keeps a record of all active and non-active cards. Upon completing a proper activation sequence, a non-active card is identified as an active card. Thereafter, the consumer who may use the card is allowed to do so, as for any subsequent transaction, the card is properly identified as an active card.

However, the use of specialized equipment to enable the activation of cards is a barrier to the widespread deployment of products that could otherwise be protected from theft by the added security of a required activation prior to use.

Furthermore, there is an increased acceptance and use of “stored-value” cards such as prepaid debit cards. These stored-value cards are particularly useful for credit challenged and unbanked consumers. With the use of stored-value cards comes a growing requirement to facilitate the easy and convenient re-loading of the cards. Specifically, there is a need for a system that allows consumers to load cash onto their stored-value cards without using the traditional banking system. Moreover, merchants currently require access to a separate system outside of the debit card transaction system in order to re-load stored-value cards with funds. As above, the use of a separate system is not only costly for merchants who must purchase separate hardware for the system, but may also be inconvenient as the hardware takes up space at a retail location and requires that employees be trained to use the separate system.

Thus, there has been a need for a system that permits a more widespread distribution and deployment of an activation and reloading system for stored-value accounts. In particular, there has been a need for an easily accessible system for converting cash to an electronic funds-holding system for subsequent uses.

### SUMMARY OF THE INVENTION

In accordance with the invention, there is provided a system and method for transferring funds into an electronic funds holding account using a debit network.

Specifically, the invention provides a method including the steps of a consumer providing a merchant having a merchant bank account with funds for a transaction amount to be transferred into the electronic funds holding account; the merchant conducting a reverse debit transaction for the transaction amount at a point of sale terminal (POST) with an electronic funds card readable by the POST, the electronic funds card associated with an electronic funds provider having an electronic funds provider bank account, the reverse debit transaction transferring the transaction amount from the merchant bank account to the electronic funds provider account; and the electronic funds provider providing the electronic funds card with access to the transaction amount in form of electronic funds.

In one embodiment, a method for transferring cash into an electronic funds holding account uses a debit network that has an operational connection to at least one point of sale terminal (POST), a banking network, a stored-value provider, and an activation service provider (ASP). The method comprises the steps of a consumer purchasing an unactivated electronic funds card from a merchant having a point of sale terminal and a merchant banking account, the unactivated electronic funds card associated with the stored-value provider having a stored-value provider banking account, and the consumer providing the merchant with cash for a transaction amount to be converted into electronic funds. At the at least one POST, the merchant conducts a reverse debit transaction at the POST for the transaction amount on the unactivated electronic funds card, and within the banking network, the reverse debit transaction is recognized and the transaction amount is transferred from the merchant banking account to the stored-value provider banking account. At the stored-value provider, confirmation is received of the transaction amount transferred to the stored-value provider banking account, the electronic funds card is loaded with the transaction amount, and an activation request is send to the ASP. At the ASP, the activation request from the stored-value provider is received and processed; the electronic funds card is activated if the electronic funds card meets predetermined activation criteria; and an approval message is returned to the POST if activation is completed.

### BRIEF DESCRIPTION OF THE DRAWINGS

The invention is described with reference to the accompanying figure in which:

FIG. 1 is a schematic network diagram in accordance with the invention.

### DETAILED DESCRIPTION OF THE INVENTION

With reference to the Figure, a method and system for converting funds to an electronic funds-holding system and activating the electronic-funds holding system for subsequent uses at a point of sale terminal (POST) using a debit card transaction system is described.

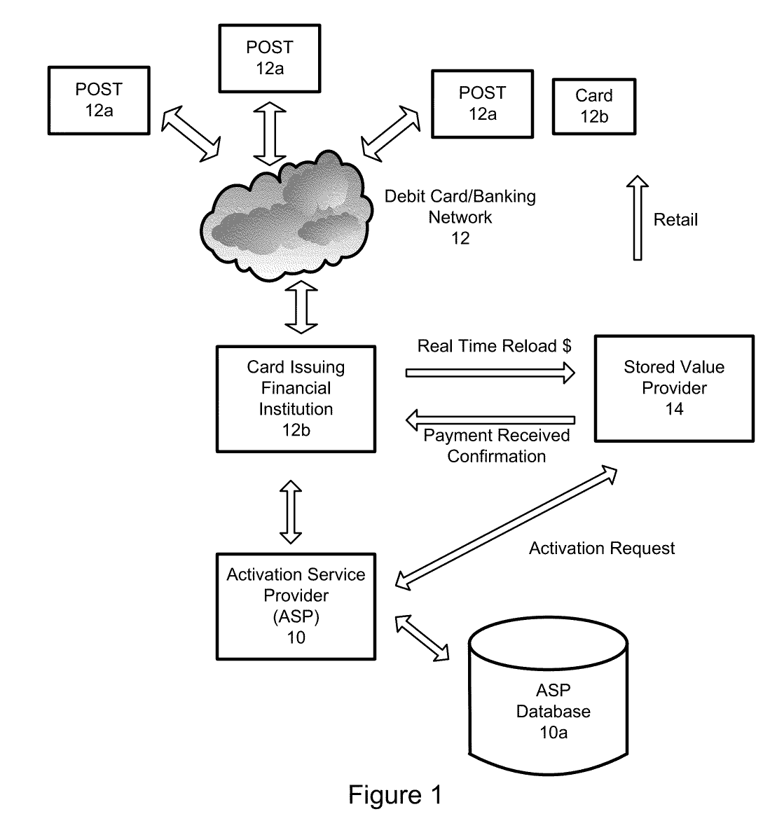

As shown in FIG. 1, stored value provider 14 is operatively connected to an existing debit card transaction network 12, individual point-of-sale terminals 12a, at least one card-issuing financial institution 12b and an activation service provider (ASP) 10 having a database 10a.

In operation, at the retail level, a consumer purchases an inactive, magnetic-swipe stripe reload voucher card 12b from any merchant that is connected to the debit card/banking network 12. The consumer purchases the card using cash or by any other conventional means such as a debit card, credit card or smart card. During purchase of the voucher card, the merchant initiates the activation and loading of funds onto the voucher card using the POST 12a.

More specifically, the loading of funds onto the purchased reload voucher 12b is conducted by a reverse transaction procedure using a POST. That is, the merchant initiates a “refund” transaction on the POST, swipes the purchased reload voucher and enters a transaction amount that the consumer has purchased to load onto the reload voucher, such as $100. The merchant then enters a merchant PIN number to access the debit card/banking network.

Upon accessing the debit card/banking network 12, the transaction information is directed to the card issuing institution and is cleared in the normal way. That is, the transaction amount is withdrawn from the merchant's account and is paid to the stored-value provider 14 for the reload voucher 12b. The stored-value provider confirms to the banking network that the payment is received, and the reload voucher is now “loaded” with the transaction amount. This transaction occurs in real time in order for the reload voucher to be “loaded” with funds almost instantly.

The reload request is also simultaneously routed from the stored value provider 14 to the activation service provider (ASP) 10 using an appropriate interface such as a VPN tunnel or a dedicated private network as known to those skilled in the art. That is, the reload request to the stored value provider acts as a trigger to advise the ASP that the reload voucher is to be activated.

Upon the ASP receiving the activation request, the ASP will interrogate the message and card information against the ASP database 10a. If the ASP determines that the activation request is legitimate, the ASP database will mark the reload voucher card as active and will send an approval response back to the POST. Alternatively, if the ASP determines that the response is invalid, a denial response will be returned to the POST.

Thus, the system enables an effective and efficient method of simultaneously loading a monetary value to a reload voucher and activating that voucher.

Once the reload voucher has been loaded with the funds, the consumer may transfer additional funds to a stored-value account using a variety of known processes including text messaging, internet accounts and/or regular phone communication to a service center.

### Reload Voucher

The reload voucher is issued by a stored-value provider and is encoded with information relating to the voucher, including an identification number and a bank identification number (BIN) that identifies the stored-value provider's bank for routing the activation transaction to the stored-value provider's bank. The reload voucher 12b is sold to the consumer by the merchant as described above.

### System Deployment

It is preferred that the system is deployed with multiple network paths and levels of redundancy in the event of network failure including dedicated T-1 circuits, frame relay circuits, ISDN switched backup lines, 56k dial-up modems and/or uninterrupted power supplies.

### Network Security

It is preferred that the system be provided with appropriate network security to enable direct connection to the banking data network. A comprehensive security system using multiple firewalls and access control lists should be provided to ensure that no unwanted traffic can pass through the ASP server to the customer's data network.

Although the present invention has been described and illustrated with respect to preferred embodiments and preferred uses thereof, it is not to be so limited since modifications and changes can be made therein which are within the full, intended scope of the invention as understood by those skilled in the art.

1. A method for transferring funds into an electronic funds holding account using a debit network, the method comprising the steps of:
a consumer providing a merchant having a merchant bank account with funds for a transaction amount to be transferred into the electronic funds holding account;
the merchant conducting a reverse debit transaction for the transaction amount at a point of sale terminal (POST) with an electronic funds card readable by the POST, the electronic funds card associated with an electronic funds provider having an electronic funds provider bank account, the reverse debit transaction transferring the transaction amount from the merchant bank account to the electronic funds provider account; and
the electronic funds provider providing the electronic funds card with access to the transaction amount in the form of electronic funds.

2. A method for transferring cash into an electronic funds holding account using a debit network having in operational connection at least one point of sale terminal (POST), a banking network, a stored-value provider, and an activation service provider (ASP), the method comprising the steps of:
a consumer purchasing an unactivated electronic funds card from a merchant having a point of sale terminal and a merchant banking account, the unactivated electronic funds card associated with the stored-value provider having a stored-value provider banking account;
the consumer providing the merchant with cash for a transaction amount to be converted into electronic funds;
at the at least one POST
the merchant conducting a reverse debit transaction at the POST for the transaction amount on the unactivated electronic funds card;
within the banking network
recognizing the reverse debit transaction and transferring the transaction amount from the merchant banking account to the stored-value provider banking account;
at the stored-value provider
receiving confirmation of the transaction amount transferred to the stored-value provider banking account;
loading the electronic funds card with the transaction amount;
sending an activation request to the ASP; and
at the ASP
receiving and processing the activation request from the stored-value provider;
activating the electronic funds card if the electronic funds card meets predetermined activation criteria; and
returning an approval message to the POST if activation is completed.
